(19) United States
(12) Patent Application Publication
(10) Pub. No.: US 2010/0251523 A1
(43) Pub. Date: Oct. 7, 2010

(54) Buckle With Housing Comprising Elastomeric Damping Mass

(75) Inventors: Ole Scharnberg, Hamburg (DE); Ronald Kliche, Schenefeld (DE)

Correspondence Address: Brinks Hofer Gilson & Lione/Ann Arbor, 524 South Main Street, Suite 200, Ann Arbor, MI, 48104, US

(73) Assignee: HAYDOCK CONSULTING SERVICES, LC, MURRAY, UT (US)

(21) Appl. No.: 12/602,588

(22) PCT Filed: May 20, 2008
(86) PCT No.: PCT/EP08/04013

§ 371 Date: Jun. 1, 2010

(30) Foreign Application Priority Data
Jun. 1, 2007 (DE) 10-2007-025-790.4

(51) Int. Cl. A44B 11/25; B60R 22/00

(52) U.S. Cl. 24/700

(57) ABSTRACT

A buckle for a seat belt harness for motor vehicles having a buckle casing and a locking and unlocking device contained therein, having a belt tongue interacting with the locking and unlocking device, the buckle casing made of plastic being provided with a damping compound for noise attenuation, is characterized in that the damping compound (12) is applied to casing shells (10, 13) on the inside of the buckle casing for the reduction of the interior volume of the casing that is not occupied by the locking and unlocking device.

### CROSS REFERENCE TO RELATED APPLICATIONS

This application claims priority to PCT/EP2008/004013 filed May 20, 2008 and DE 10 2007 025 790.4, filed Jun. 1, 2007.

### FIELD OF INVENTION

The present invention relates to a buckle for a seat belt harness for motor vehicles having a buckle casing and a locking and an unlocking device contained therein, and having a belt tongue interacting with the locking and unlocking device, wherein the buckle casing is made of plastic is provided with a damping compound for noise attenuation.

### BACKGROUND OF INVENTION

The buckle having the above mentioned characteristics has been described in DE 102 59 115 A1. Insofar as the buckle that is installed in a motor vehicle causes rattling noise by hitting other installations of the motor vehicle, it is proposed to prevent and/or attenuate said rattling noise by applying a damping layer to the outside of the casing. Insofar as foam material is proposed as a damping material, the production of the casing cap forming the casing is addressed by means of insert-molding (in particular by means of two-component insert molding) in a single operation.

### DESCRIPTION OF THE INVENTION

In its fundamental idea, the invention provides that the damping compound is applied to the case shells on the inside of the buckle casing to reduce the interior volume of the casing that is not occupied by the locking and unlocking device. The invention is associated with the advantage that the free interior volume of the buckle casing that is not occupied by the functional components of the locking and/or unlocking device are possibly filled with the damping compound, so that the functional noises are not prevented, but their propagation in the buckle casing is prevented. In this way, a reduction of the sound pressure level inside the buckle casing is advantageously accomplished, namely to a frequency range of approx. 1,600 Hz, relevant to a passenger's hearing. Not only is the sound pressure level reduced as a whole, but the sound audible outside of the casing is generated that is more pleasant to the person concerned, because it is at a lower frequency.

### BRIEF DESCRIPTION OF THE DRAWINGS

FIG. 1 illustrates the upper shell of the buckle in accordance with this invention; and

FIG. 2 illustrates the lower shell of the buckle in accordance with this invention.

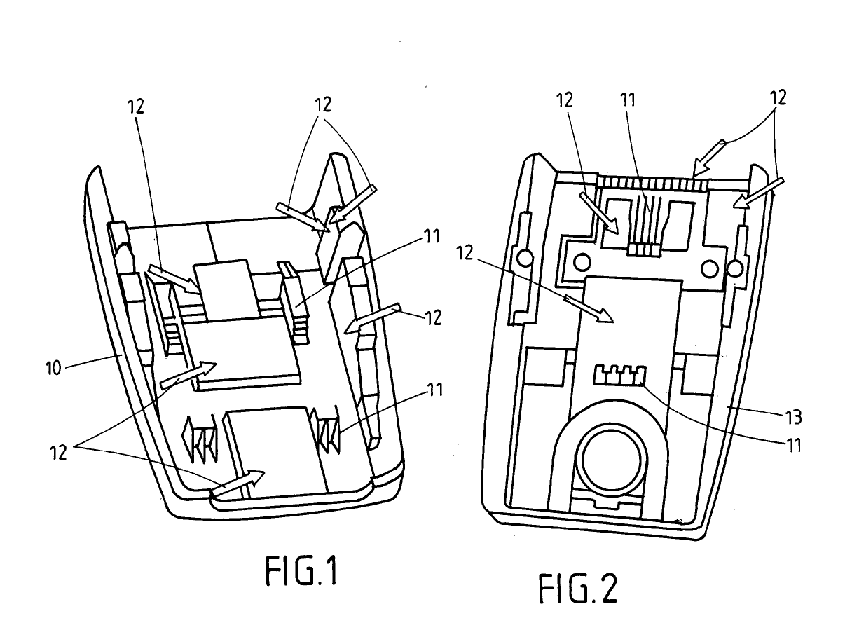

### DETAILED DESCRIPTION OF THE INVENTION

Insofar as only the upper shell 10 and the lower shell 13 of a buckle casing are illustrated in the drawing, the additional illustration of the functional parts forming the locking and unlocking device located in the buckle casing has been dispensed with. The present invention does not specifically involve the functional parts which moreover are part of the different prior art designs of buckles known to a person skilled in the art. Gatings 11 are attached to both casing shells 10 and 13 shown in the drawing for fixing and/or connecting the corresponding functional parts. Damping compounds designated with the reference numeral 12 are additionally applied to the upper shell 10 and lower shell 13 for the reduction of the free interior volume of a buckle casing formed by the upper shell 10 and lower shell 13. The casing shells 10 and 13 are in particular made of an ABS plastic, whereas the damping compound 12 is made of thermoplastic polyurethane. By using both these materials it is possible to produce the upper shell 10 and/or lower shell 13 together with the damping compound 12 to be applied thereto in a single operation by means of a two-component injection molding process.

1. A buckle for a seat belt harness for motor vehicles having a buckle casing formed by a pair of casing shells and a locking and unlocking device contained therein, and having a belt tongue interacting with the locking and unlocking device, comprising the buckle casing is made of plastic and provided with a damping compound for noise attenuation, the damping compound (12) is applied to the casing shells (10, 13) on the inside of the buckle casing for the reduction of the interior volume of the casing that is not occupied by the locking and unlocking device.

2. The buckle according to claim 1, further comprising in that the casing shells (10, 13) are made of ABS plastic and the damping compound (12) is made of thermoplastic polyurethane.

3. The buckle according to claim 1, further comprising in that the casing shells (10, 13) with the damping compound (12) connected thereto are produced by injection molding in a single operation.

4. The buckle according to claim 3, further comprising in that the casing shells (10, 13) are produced together with the damping compound (12) by means of two-component injection molding.
